(19) United States
(12) Patent Application Publication
(10) Pub. No.: US 2007/0012095 A1
(43) Pub. Date: Jan. 18, 2007

(54) Scanning probe microscope

(75) Inventor: Katsuyuki Suzuki, Tokyo (JP)

Correspondence Address: THE WEBB LAW FIRM, P.C., 700 KOPPERS BUILDING, 436 SEVENTH AVENUE, PITTSBURGH, PA, 15219, US

(73) Assignee: JEOL Ltd., Akishima (JP)

(21) Appl. No.: 11/481,401

(22) Filed: Jul. 5, 2006

(30) Foreign Application Priority Data
Jul. 11, 2005 (JP) 2005-201600

(51) Int. Cl. G01N 13/10

(52) U.S. Cl. 73/105

(57) ABSTRACT

A scanning probe microscope for precisely measuring the elasticity or plastic deformation of a sample surface without being affected by the adsorption layer of the sample surface. The probe of the microscope and the sample are placed at a distance from each other. The probe and sample are brought into contact with each other, or the probe and the sample, which are in contact with each other, are brought out of contact with each other. The microscope is equipped with an oscillation unit for oscillating the probe laterally. The measurement is performed within the atmosphere or in a low-pressure ambient.

### BACKGROUND OF THE INVENTION

1. Field of the Invention

The present invention relates to a scanning probe microscope that is a general term for a family of instruments including scanning tunneling microscope, atomic force microscope, magnetic force microscope, friction force microscope, viscoelasticity microscope (VE-AFM), scanning Kelvin probe microscope (SKPM), scanning near field microscope, and other similar instruments.

2. Description of Related Art

In recent years, a scanning probe microscope for obtaining a topographical image of a surface of a sample has attracted attention. In particular, the microscope has a cantilever equipped with a probe. The cantilever is placed opposite to the sample. The distance between the probe and sample is set to nanometers or less. The probe is scanned over the sample surface to measure a physical amount, such as an interatomic force exerted between the probe and sample. The topographical image is derived based on the result of the measurement. The used method of measuring the physical amount acting on the probe consists of irradiating the rear surface of the cantilever having the probe with laser light, receiving the reflected laser light by a photodetector, and measuring the displacement of the position.

The cantilever that is at a position remote from the sample surface is brought close to the sample surface. Then, the cantilever is brought into contact with the surface and pushed into the surface. The cantilever is then moved away from the surface. These process steps are carried out continuously. Variations in the flexure of the cantilever are measured. FIG. 2 is a force curve in which the distance traveled by the cantilever is plotted on the horizontal axis, while the variation in the flexure of the cantilever is on the vertical axis.

If the sample is a soft substance, such as high polymer, and if the cantilever is pushed into it, elastic deformation occurs at the surface of the sample. As shown in FIG. 3, during going excursion of the cantilever, the probe is pushed into the sample while deforming it. Therefore, the cantilever bends a large amount. During returning excursion, the sample returns to its original state with a time delay. Therefore, the cantilever bends a less amount. In this way, in the force curve, there is a difference between the going and returning excursions. The elasticity or plastic deformation of a microscopic region on a surface of a sample can be measured by measuring the force curve in this way.

However, within the atmosphere, every sample surface contains a water layer. Under this condition, if the force curve is measured, the cantilever is adsorbed onto the sample surface by the water layer as shown in FIG. 4. When the cantilever leaves the sample surface, the cantilever is pulled toward the water layer and thus bends to a great extent in the direction opposite to the direction of flexure occurring during the going excursion. Consequently, the profile of the force curve is dominantly affected by adsorption performed by the wafer layer. This makes it impossible to precisely measure the elasticity or plastic deformation of the sample surface.

Measurements are performed within vacuum or water in order to reduce the effects of the adsorbing force of wafer. However, dedicated equipment is necessary. Furthermore, there is a possibility that the sample surface is changed in quality within vacuum or water.

One prior-art technique is described, for example, in Japanese patent laid-open No. H9-304407 and is an atomic force microscope in which lateral vibration is applied to prevent the probe from touching the sample. Another prior-art technique is described, for example, in patent Japanese patent laid-open No. H9-13137 and is a frictional force-measuring instrument in which the cantilever is oscillated in a lateral direction and the resulting frictional force is measured.

### SUMMARY OF THE INVENTION

The present invention provides a technique for solving the problem that the elasticity or plastic deformation of a sample surface cannot be measured precisely due to the effects of the adsorption layer at the sample surface.

A first embodiment of the present invention provides a scanning probe microscope having a probe and designed to perform a measurement by bringing the probe and a sample, which are at a distance from each other, close to each other and bringing them into contact with each other or by bringing the probe and the sample, which are in contact with each other, out of contact with each other. This microscope is characterized in that it is equipped with an oscillation means for applying lateral oscillations to the probe.

A second embodiment of the present invention provides a scanning probe microscope which is based on the first embodiment and further characterized in that the measurement is performed within the atmosphere or in a low-vacuum ambient.

A third embodiment of the present invention provides a scanning probe microscope which is based on the first or second embodiment and further characterized in that the probe is attached to the free end of the cantilever. The oscillation means is a shear piezoelectric element. The microscope further includes a means for detecting flexure of the cantilever and a driving means for varying the distance between the sample and the probe. A force curve of the sample is obtained from the flexure of the cantilever.

A fourth embodiment of the present invention provides a scanning probe microscope which is based on any one of the first through third embodiments and further characterized in that the oscillation means applies oscillations having an amplitude smaller than the amplitude of the probe at resonance.

A fifth embodiment of the present invention provides a method of performing a measurement using a scanning probe microscope by bringing a probe and a sample, which are at a distance from each other, close to each other and into contact with each other or by bringing the probe and the sample, which are in contact with each other, out of contact with each other. During the measurement, lateral oscillations are applied to the probe by oscillation means.

The cantilever is oscillated laterally in accordance with an embodiment of the present invention. This reduces the effects of the adsorption layer at the sample surface. Consequently, the elasticity or plastic deformation of the sample surface can be measured precisely. At this time, any special equipment that enables measurements within vacuum or water is not necessary. Furthermore, it is unlikely that the sample surface is changed in quality by the effects of vacuum or water.

Other objects and features of the invention will appear in the course of the description thereof, which follows.

### BRIEF DESCRIPTION OF THE DRAWINGS

FIG. 1 is a block diagram of a prior-art instrument;

FIG. 2 is a diagram illustrating a measurement of a force curve in a case where the measurement is not affected by the adsorbing force of a sample surface;

FIG. 3 is a diagram illustrating a measurement of a force curve in a case where the measurement is not affected by the adsorbing force of a sample surface and the sample has deformed elastically;

FIG. 4 is a diagram illustrating a measurement of a force curve by a prior-art technique in a case where the sample surface has an adsorption layer;

FIG. 5 is a block diagram of an instrument according to an embodiment of the present invention;

FIG. 6 is a diagram illustrating the manner in which a force curve is measured by a method according to an embodiment of the present invention in a case where a sample surface has an adsorption layer;

FIG. 7 is a detailed side elevation of a cantilever according to an embodiment of the present invention; and

FIG. 8 is a view taken along the arrow B of FIG. 7.

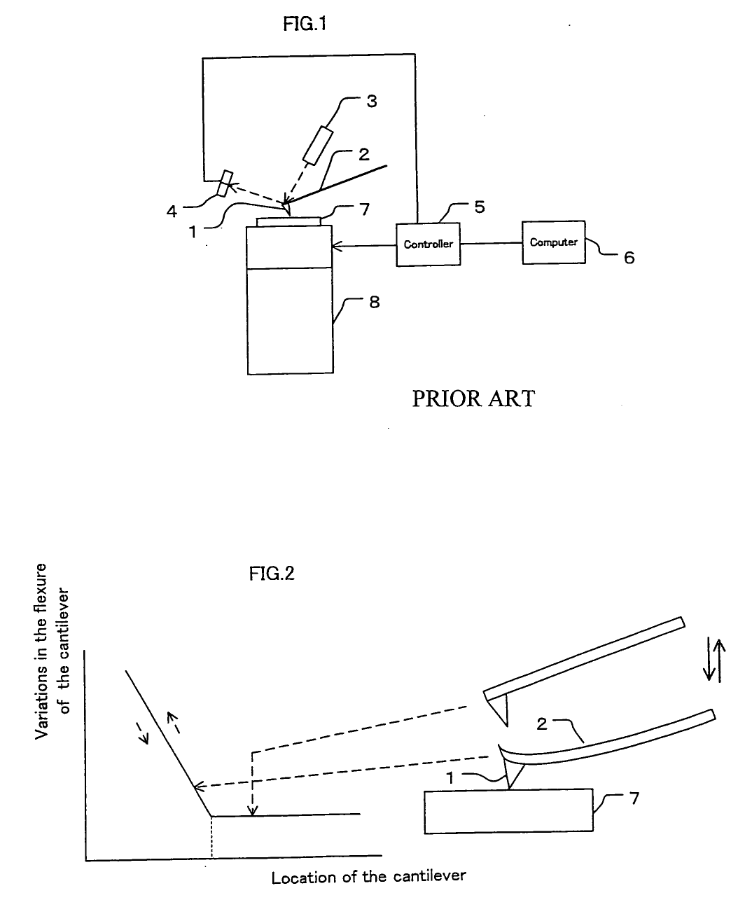

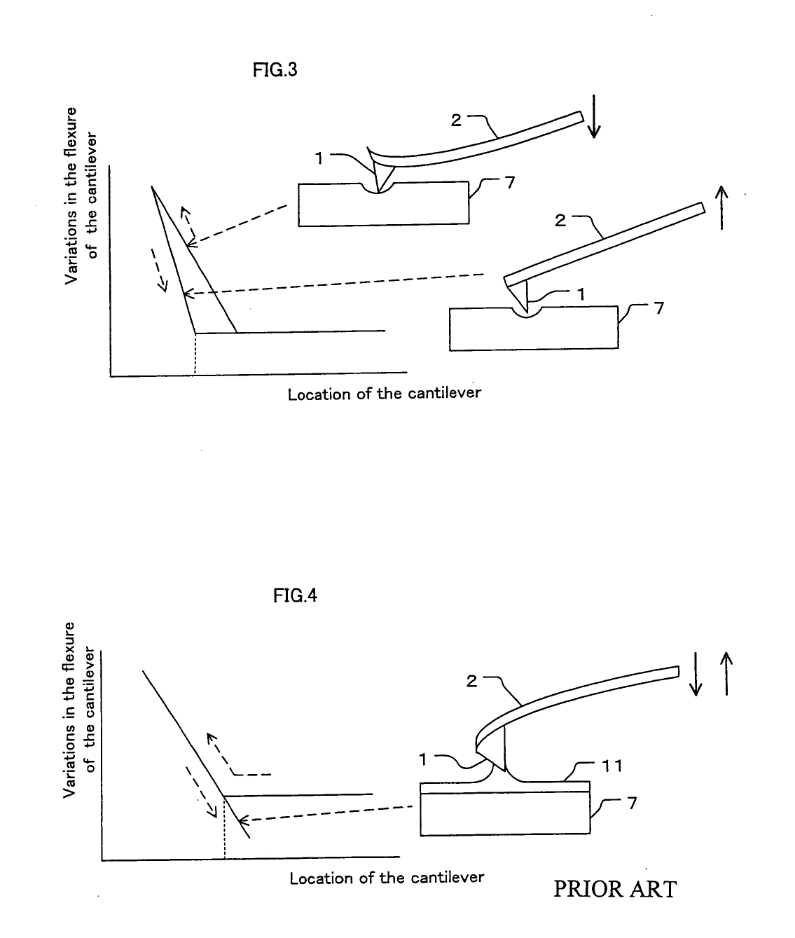

### DESCRIPTION OF THE PREFERRED EMBODIMENTS

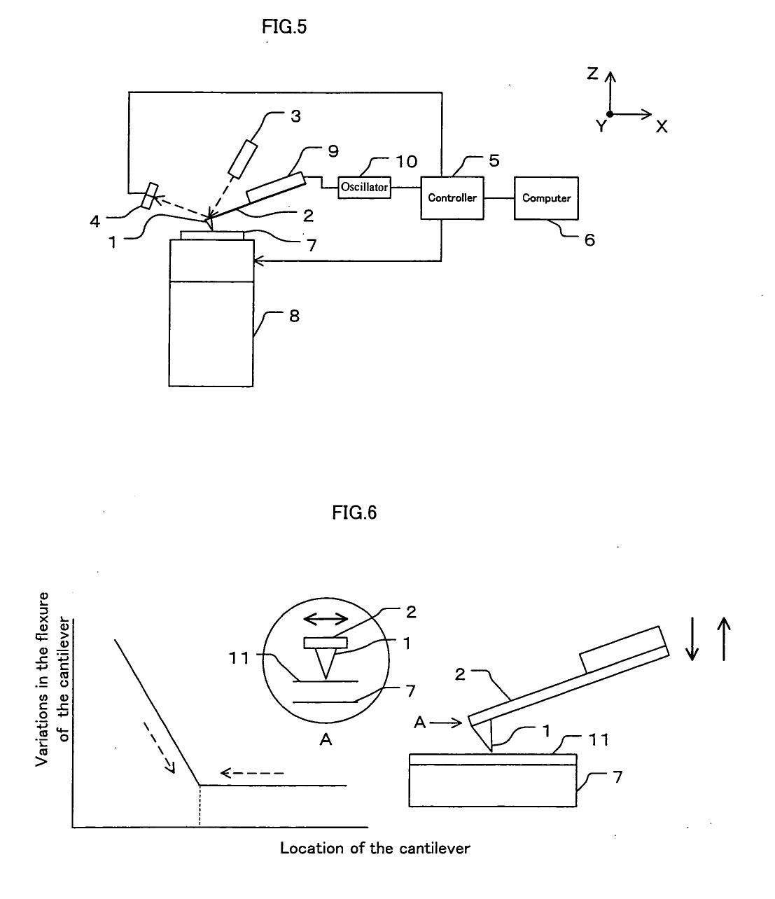

An instrument having a configuration according to an embodiment of the present invention is described by referring to FIG. 5. This instrument is placed within the atmosphere and equipped with a cantilever 2 having a probe 1 at its front end. The cantilever 2 is placed opposite to a sample 7. The sample 7 is placed on the top surface of a scanner made of a tubular piezoelectric element. The sample 7 can be displaced within the X-Y plane, i.e., along the sample surface. The interatomic force exerted between the probe 1 and sample 7 is detected from the flexure of the cantilever 2. Laser light is shot at the tip of the cantilever 2. The reflection spot of the laser light is detected by a detector 4. The optical detection system makes use of optical leverage. A minute displacement of the cantilever 2 is magnified, projected onto the detector 4, and detected. A two- or four-segmented photodiode is used as the detector 4. Positional information is obtained by calculating the difference between output signals from the segments of the photodiode by means of an arithmetic circuit.

A shear piezoelectric element 9 is installed on the top surface of the fixed end of the cantilever 2 to oscillate the cantilever 2 laterally, i.e., in the Y-direction. An oscillator 10 is connected with the piezoelectric element 9. A signal for oscillating the cantilever 2 laterally is applied to the piezoelectric element from the oscillator 10.

The detector 4, oscillator 10, and a scanner 8 are connected with a controller 5, which, in turn, is connected with a computer 6.

The structures of the various portions of the instrument shown in FIG. 5 have been described so far. The operation of the instrument is next described. When the atomic force microscope is in contact mode, imaging and measurements are performed using the interatomic force between the surface of the sample 7 and the probe 1. If the probe 1 attached to the end of the cantilever is brought close to the surface of the sample 7, an interatomic force is exerted between the sample 7 and the probe 1. Therefore, the surface of the sample 7 is observed based on control of the distance between the probe 1 and the sample 7 or on the interatomic force. When the distance between the sample 7 and the probe 1 is large, the interatomic force is attractive. When the distance is small, the interatomic force is repulsive. This interatomic force causes the cantilever to bend. Accordingly, the flexure of the cantilever is detected by optical leverage using laser light. The position of either the probe 1 or of the sample 7 is controlled within the X-Y plane and in the Z-direction such that the interatomic force is kept constant by a driving means, such as the scanner 8 using the piezoelectric element. The surface of the sample 7 is scanned in two dimensions. Thus, a topographic image of the sample is produced and observed.

In particular, if the tip of the cantilever 2 is displaced up and down and the position of the reflection spot deviates, the result of the calculated difference between the output signals varies. In response to the variation, the controller 5 sends an output signal to the scanner 8 to minimize the error from the reference position. Where the cantilever 2 is shifted upward, for example, the scanner 8 is contracted by the feedback circuit, so that the cantilever 2 assumes the original posture and position. In this scanning probe microscope, the surface of the sample 7 is scanned under feedback control in which the interatomic force acting between the probe 1 and the sample 7 is held constant. At this time, a voltage is applied to the scanner 8 to produce Z-motion of the scanner. The voltage is converted into a distance. The voltage is imaged as topographic information by the computer 6 based on data about the distance.

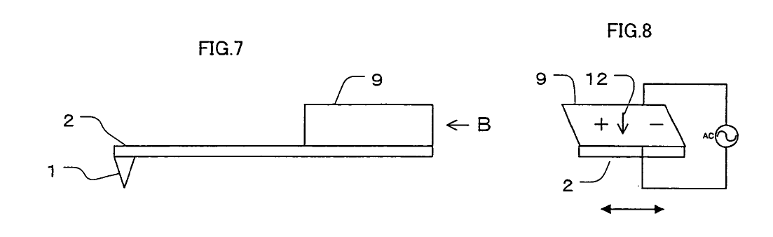

An oscillation signal is applied to the shear piezoelectric element 9 from the oscillator 10 to oscillate the cantilever 2 laterally. FIG. 7 is a detailed side elevation of the cantilever 2. FIG. 8 is a view taken along the arrow B of FIG. 7. The piezoelectric element 9 is polarized in the direction indicated by 12. If a voltage is applied in the direction of polarization 12, the upper and lower parts of the shear piezoelectric element 9 oscillate so as to shear it. The cantilever 2 having the probe 1 fixed to the piezoelectric element 9 also oscillates laterally. Since the amplitude of the applied oscillations is smaller than the amplitude of the resonating cantilever, the tip of the probe is not displaced.

Under this condition, a force curve is measured. In FIG. 6, if the surface of the sample 7 has a water layer 11, the tip of the cantilever 2 is not easily adsorbed onto the water layer 11 when the cantilever 2 leaves the surface of the sample 7 because the cantilever 2 is oscillating laterally. The tip of the cantilever does not bend greatly. That is, when the cantilever is brought close to the sample (going excursion; to the left in the graph), the flexure does not vary until the cantilever touches the sample. If the cantilever is brought closer, the flexure increases. The reverse situation occurs when the cantilever is moved away from the sample. Consequently, the effects of the water layer 11 on the force curve can be reduced. The elasticity or plastic deformation of the surface of the sample 7 can be measured precisely as shown in FIG. 6.

The operation of the instrument has been described so far. This instrument is a scanning probe microscope for observing the topography or physical properties of a surface of a sample by bringing a cantilever close to the surface of the sample and using the force exerted between the sample and the tip of the cantilever. The force to push the cantilever into the sample is varied continuously. The resulting flexure of the cantilever is detected. A force curve is obtained to measure a physical property, such as elasticity or plastic deformation of the sample surface. At this time, the cantilever is oscillated laterally to reduce the effects of the adsorption layer of water at the surface of the sample. The elasticity or plastic deformation of the sample surface can be measured precisely. For this measurement, any special equipment permitting the measurement to be performed in vacuum or water is not necessary. Furthermore, the surface of the sample 7 does not change in quality within vacuum or water.

It is to be understood that the present invention is not limited to the above embodiment but rather various modifications are possible. The invention can also be applied to other types of scanning probe microscopes, such as scanning tunneling microscope, magnetic force microscope, frictional force microscope, viscoelasticity microscope (VE-AFM), scanning Kelvin probe microscope (SKPM), or scanning near field microscope.

The instrument may be placed in a low-vacuum ambient in which the sample surface contains water.

In addition, the adsorption layer of the sample surface is not limited to a water layer. The adsorption layer may also be a sticky layer of oil or sample.

Having thus described my invention with the detail and particularity required by the Patent Laws, what is desired protected by Letters Patent is set forth in the following claims.

The invention claimed is:

1. A scanning probe microscope for performing a measurement by bringing a probe and a sample, which are located at a distance from each other, close to each other and bringing the probe and the sample into contact with each other or by bringing the probe and the sample, which are in contact with each other, out of contact with each other, said scanning probe microscope having oscillation means for oscillating the probe laterally.

2. A scanning probe microscope as set forth in claim 1, wherein said measurement is performed within the atmosphere or in a low-vacuum ambient.

3. A scanning probe microscope as set forth in claim 1 or 2,
wherein said probe is attached to a free end of a cantilever,
wherein said oscillation means is a shear piezoelectric element,
wherein there are further provided detection means for detecting flexure of said cantilever and driving means for varying the distance between the sample and the probe, and
wherein a force curve of the sample is obtained according to the flexure of the cantilever.

4. A scanning probe microscope as set forth in claim I or 2, wherein said oscillation means produces oscillations having an amplitude smaller than the amplitude of the probe at resonance.

5. A method of performing a measurement using a scanning probe microscope by bringing a probe and a sample, which are located at a distance from each other, close to each other and bringing the probe and the sample into contact with each other or by bringing the probe and the sample, which are in contact with each other, out of contact with each other,
wherein the probe is oscillated laterally by oscillation means during the measurement.
